(19) United States
(12) Patent Application Publication
(10) Pub. No.: US 2025/0133536 A1
(43) Pub. Date: Apr. 24, 2025

(54) PRE-PAGING MONITORING FOR NON-TERRESTRIAL NETWORKS

(71) Applicant: QUALCOMM Incorporated, San Diego, CA (US)

(72) Inventors: Chiranjib SAHA, Lakeside, CA (US); Xiao Feng WANG, San Diego, CA (US); Syed Hashim Ali SHAH, San Diego, CA (US); Le LIU, San Jose, CA (US)

(21) Appl. No.: 18/490,226

(22) Filed: Oct. 19, 2023

(51) Int. Cl. H04W 68/02; H04W 8/22; H04W 56/00; H04W 68/00; H04W 84/06

(52) U.S. Cl. CPC H04W 68/02; H04W 8/22; H04W 56/001; H04W 68/005; H04W 84/06

(57) ABSTRACT

Methods, systems, and devices for wireless communications are described. A non-terrestrial network (NTN) cell may transmit a pre-paging message for which a user equipment (UE) may monitor based on a synchronization signal block (SSB) and a pre-paging configuration. For example, the UE may be configured with a pre-paging configuration for one or more NTN cells that may be used to identify an SS and a CORESET in which to monitor for a pre-paging message. The UE may identify the pre-paging configuration for a specific NTN cell based on a cell identifier for the NTN cell identified based on decoding an SSB from the NTN cell. The UE may identify the CORESET and the SS based on the pre-paging configuration and the resource via which the SSB was received. Thus a UE may receive a pre-paging message from an NTN based on receiving and decoding an SSB in low SINR scenarios.

### FIELD OF TECHNOLOGY

The following relates to wireless communications, including pre-paging monitoring for non-terrestrial networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support pre-paging monitoring for non-terrestrial networks (NTNs). User equipments (UEs) may receive synchronization signal blocks (SSBs) at a lower signal to interference and noise ratio (SINR) than system information block 1 (SIB1). SIB1 may be used to indicate a resource to monitor (for example, a control resource set (CORESET) and search space (SS)) for paging messages from an NTN cell. An NTN cell may transmit a pre-paging message for which a UE may monitor in a resource based on an SSB and a pre-paging configuration. Accordingly, the UE may monitor for and receive a pre-paging message from an NTN cell at relatively low SINR scenarios (for example, in non-line of sight (nLOS) scenarios between a UE and a non-terrestrial (NT) network entity). For example, before a UE enters a radio resource control (RRC) inactive mode, the UE may be configured with a pre-paging configuration for one or more NTN cells that may be used to identify an SS and a CORESET in which to monitor for a pre-paging message. The UE may identify the pre-paging configuration for a specific NTN cell based on identifying a cell identifier (ID) for the NTN cell based on decoding an SSB from the NTN cell. The UE may identify the CORESET and the SS based on the pre-paging configuration and the resource via which the SSB was received. Thus a UE may receive a pre-paging message from an NTN based on receiving and decoding an SSB in scenarios where the SINR of the link with the NTN is insufficient to receive SIB1.

A method for wireless communications by a UE is described. The method may include receiving, from an NT network entity while in an RRC idle mode or an RRC inactive mode, an SSB, where the SSB is indicative of a cell ID of the NT network entity, determining, based on the cell ID, a SS and a CORESET for a downlink control channel monitoring occasion for a pre-paging message from the NT network entity, where the pre-paging message includes a UE ID, and receiving, from the NT network entity via the downlink control channel monitoring occasion, the pre-paging message.

A UE for wireless communications is described. The UE may include one or more memories storing processor executable code, and one or more processors coupled with the one or more memories. The one or more processors may individually or collectively operable to execute the code to cause the UE to receive, from an NT network entity while in an RRC idle mode or an RRC inactive mode, an SSB, where the SSB is indicative of a cell ID of the NT network entity, determine, based on the cell ID, a SS and a CORESET for a downlink control channel monitoring occasion for a pre-paging message from the NT network entity, where the pre-paging message includes a UE ID, and receive, from the NT network entity via the downlink control channel monitoring occasion, the pre-paging message.

Another UE for wireless communications is described. The UE may include means for receiving, from an NT network entity while in an RRC idle mode or an RRC inactive mode, an SSB, where the SSB is indicative of a cell ID of the NT network entity, means for determining, based on the cell ID, a SS and a CORESET for a downlink control channel monitoring occasion for a pre-paging message from the NT network entity, where the pre-paging message includes a UE ID, and means for receiving, from the NT network entity via the downlink control channel monitoring occasion, the pre-paging message.

A non-transitory computer-readable medium storing code for wireless communications is described. The code may include instructions executable by a processor to receive, from an NT network entity while in an RRC idle mode or an RRC inactive mode, an SSB, where the SSB is indicative of a cell ID of the NT network entity, determine, based on the cell ID, a SS and a CORESET for a downlink control channel monitoring occasion for a pre-paging message from the NT network entity, where the pre-paging message includes a UE ID, and receive, from the NT network entity via the downlink control channel monitoring occasion, the pre-paging message.

In some examples of the method, UEs, and non-transitory computer-readable medium described herein, receiving the pre-paging message may include operations, features, means, or instructions for receiving, in the pre-paging message, an indication of a paging cause.

In some examples of the method, UEs, and non-transitory computer-readable medium described herein, receiving the pre-paging message may include operations, features, means, or instructions for receiving a downlink control information with a cyclic redundancy check scrambled by a second part of a pre-paging ID for the UE, where the UE ID may be a first part of the pre-paging ID for the UE.

Some examples of the method, UEs, and non-transitory computer-readable medium described herein may further include operations, features, means, or instructions for receiving, from the NT network entity or another network entity prior to reception of the SSB, an indication of the pre-paging ID for the UE.

Some examples of the method, UEs, and non-transitory computer-readable medium described herein may further include operations, features, means, or instructions for receiving, from the NT network entity or another network entity prior to reception of the SSB, an indication of a pre-paging configuration associated with the cell ID, where determining the SS and the CORESET may be based on the pre-paging configuration.

In some examples of the method, UEs, and non-transitory computer-readable medium described herein, determining the CORESET may include operations, features, means, or instructions for determining the CORESET based on a frequency resource via which the SSB may be received.

In some examples of the method, UEs, and non-transitory computer-readable medium described herein, receiving the indication of the pre-paging configuration may include operations, features, means, or instructions for receiving an indication of a set of multiple pre-paging configurations associated with a set of multiple respective cell IDs, where the set of multiple pre-paging configurations includes the pre-paging configuration, and where the set of multiple respective cell IDs includes the cell ID.

In some examples of the method, UEs, and non-transitory computer-readable medium described herein, receiving the indication of the pre-paging configuration may include operations, features, means, or instructions for receiving system information from the NT network entity or the other network entity that includes the indication of the pre-paging configuration.

In some examples of the method, UEs, and non-transitory computer-readable medium described herein, receiving the indication of the pre-paging configuration may include operations, features, means, or instructions for receiving a unicast RRC message from the NT network entity or the other network entity that includes the indication of the pre-paging configuration.

Some examples of the method, UEs, and non-transitory computer-readable medium described herein may further include operations, features, means, or instructions for receiving, from the NT network entity or another network entity prior to reception of the SSB, an indication of a CORESET configuration associated with a set of cell IDs, where the set of cell IDs includes the cell ID, where the CORESET for the downlink control channel monitoring occasion may be identified based on a frequency resource via which the SSB may be received and the CORESET configuration and receiving, from the NT network entity, a master information block that indicates the SS.

In some examples of the method, UEs, and non-transitory computer-readable medium described herein, the SSB includes an indication that the NT network entity supports pre-paging and the UE determines the SS and the CORESET based on the indication that the NT network entity supports pre-paging.

Some examples of the method, UEs, and non-transitory computer-readable medium described herein may further include operations, features, means, or instructions for receiving, from a second NT network entity, a second SSB including an indication that the second NT network entity does not support pre-paging, where the second SSB may be indicative of a second cell ID of the second NT network entity and refraining, based on the indication that the second NT network entity does not support pre-paging and based on the second cell ID, from determining a second SS and a second CORESET for a second downlink control channel monitoring occasion for a second pre-paging message from the second NT network entity.

A method for wireless communications by an NT network entity is described. The method may include transmitting, to a UE in an RRC idle mode or an RRC inactive mode with the NT network entity, an SSB, where the SSB is indicative of a cell ID of the NT network entity and transmitting, to the UE via a downlink control channel monitoring occasion, a pre-paging message including a UE ID, where a SS and a CORESET for the downlink control channel monitoring occasion are based on the cell ID.

A NT network entity for wireless communications is described. The NT network entity may include one or more memories storing processor executable code, and one or more processors coupled with the one or more memories. The one or more processors may individually or collectively operable to execute the code to cause the NT network entity to transmit, to a UE in an RRC idle mode or an RRC inactive mode with the NT network entity, an SSB, where the SSB is indicative of a cell ID of the NT network entity and transmit, to the UE via a downlink control channel monitoring occasion, a pre-paging message including a UE ID, where a SS and a CORESET for the downlink control channel monitoring occasion are based on the cell ID.

Another NT network entity for wireless communications is described. The NT network entity may include means for transmitting, to a UE in an RRC idle mode or an RRC inactive mode with the NT network entity, an SSB, where the SSB is indicative of a cell ID of the NT network entity and means for transmitting, to the UE via a downlink control channel monitoring occasion, a pre-paging message including a UE ID, where a SS and a CORESET for the downlink control channel monitoring occasion are based on the cell ID.

A non-transitory computer-readable medium storing code for wireless communications is described. The code may include instructions executable by a processor to transmit, to a UE in an RRC idle mode or an RRC inactive mode with the NT network entity, an SSB, where the SSB is indicative of a cell ID of the NT network entity and transmit, to the UE via a downlink control channel monitoring occasion, a pre-paging message including a UE ID, where a SS and a CORESET for the downlink control channel monitoring occasion are based on the cell ID.

In some examples of the method, NT network entities, and non-transitory computer-readable medium described herein, transmitting the pre-paging message may include operations, features, means, or instructions for transmitting, in the pre-paging message, an indication of a paging cause.

In some examples of the method, NT network entities, and non-transitory computer-readable medium described herein, transmitting the pre-paging message may include operations, features, means, or instructions for transmitting a downlink control information with a cyclic redundancy check scrambled by a second part of a pre-paging ID for the UE, where the UE ID may be a first part of the pre-paging ID for the UE.

Some examples of the method, NT network entities, and non-transitory computer-readable medium described herein may further include operations, features, means, or instructions for transmitting, to the UE prior to transmission of the SSB, an indication of the pre-paging ID for the UE.

Some examples of the method, NT network entities, and non-transitory computer-readable medium described herein may further include operations, features, means, or instructions for transmitting, to the UE prior to transmission of the SSB, an indication of a pre-paging configuration associated with the cell ID, where the SS and the CORESET for the downlink control channel monitoring occasion may be based on the pre-paging configuration.

In some examples of the method, NT network entities, and non-transitory computer-readable medium described herein, the CORESET for the downlink control channel monitoring occasion may be based on a frequency resource via which the SSB may be transmitted.

In some examples of the method, NT network entities, and non-transitory computer-readable medium described herein, transmitting the indication of the pre-paging configuration may include operations, features, means, or instructions for transmitting an indication of a set of multiple pre-paging configurations associated with a set of multiple respective cell IDs, where the set of multiple pre-paging configurations includes the pre-paging configuration, and where the set of multiple respective cell IDs includes the cell ID.

In some examples of the method, NT network entities, and non-transitory computer-readable medium described herein, transmitting the indication of the pre-paging configuration may include operations, features, means, or instructions for transmitting system information that includes the indication of the pre-paging configuration.

In some examples of the method, NT network entities, and non-transitory computer-readable medium described herein, transmitting the indication of the pre-paging configuration may include operations, features, means, or instructions for transmitting a unicast RRC message that includes the indication of the pre-paging configuration.

Some examples of the method, NT network entities, and non-transitory computer-readable medium described herein may further include operations, features, means, or instructions for transmitting, to the UE prior to transmission of the SSB, an indication of a CORESET configuration associated with a set of cell IDs, where the set of cell IDs includes the cell ID, where the CORESET for the downlink control channel monitoring occasion may be identified based on a frequency resource via which the SSB may be received and the CORESET configuration and transmitting, to the UE, a master information block that indicates the SS.

In some examples of the method, NT network entities, and non-transitory computer-readable medium described herein, the SSB includes an indication that the NT network entity supports pre-paging.

### BRIEF DESCRIPTION OF THE DRAWINGS

FIG. 1 shows an example of a wireless communications system that supports pre-paging monitoring for non-terrestrial networks (NTNs) in accordance with one or more aspects of the present disclosure.

FIG. 2 shows an example of a wireless communication system that supports pre-paging monitoring for NTNs in accordance with one or more aspects of the present disclosure.

FIG. 3 shows an example of a resource diagram that supports pre-paging monitoring for NTNs in accordance with one or more aspects of the present disclosure.

FIG. 4 shows an example of a process flow that supports pre-paging monitoring for NTNs in accordance with one or more aspects of the present disclosure.

FIGS. 5 and 6 show block diagrams of devices that support pre-paging monitoring for NTNs in accordance with one or more aspects of the present disclosure.

FIG. 7 shows a block diagram of a communications manager that supports pre-paging monitoring for NTNs in accordance with one or more aspects of the present disclosure.

FIG. 8 shows a diagram of a system including a device that supports pre-paging monitoring for NTNs in accordance with one or more aspects of the present disclosure.

FIGS. 9 and 10 show block diagrams of devices that support pre-paging monitoring for NTNs in accordance with one or more aspects of the present disclosure.

FIG. 11 shows a block diagram of a communications manager that supports pre-paging monitoring for NTNs in accordance with one or more aspects of the present disclosure.

FIG. 12 shows a diagram of a system including a device that supports pre-paging monitoring for NTNs in accordance with one or more aspects of the present disclosure.

FIGS. 13 and 14 show flowcharts illustrating methods that support pre-paging monitoring for NTNs in accordance with one or more aspects of the present disclosure.

### DETAILED DESCRIPTION

In some scenarios, a user equipment (UE) may be served by a non-terrestrial network (NTN) (e.g., serviced by satellites), for example, when the UE is located at a location on the ocean or at remote desert or rural locations. In such scenarios, the NTN may transmit paging messages to the UE when the UE is camped on an NTN cell in a radio resource control (RRC) idle or RRC inactive mode. For example, paging messages may be transmitted via a downlink control information (DCI) for safety or emergency purposes or to indicate an incoming short message service (SMS) or voice call to the UE. To camp on an NTN cell to receive paging messages, the UE may monitor a physical downlink control channel (PDCCH) monitoring occasion for DCI based on information in a system information block (SIB) 1 (SIB1) from the NTN cell. In order to receive and decode a SIB1 the UE may receive a synchronization signal block (SSB) from the NTN and decode the physical broadcast channel (PBCH) in the SSB, where the PBCH may include a master information block (MIB) that indicates a control resource set (CORESET) and search space (SS) for the PDCCH that schedules the SIB1. Decoding of SIB1 may demand a higher signal to interference and noise ratio (SINR) than SSBs, as SIB1 may be more information-intensive than SSBs. In some scenarios, a UE may have a sufficient SINR for a connection with an NTN cell to receive and decode an SSB but may not have a sufficient SINR to receive and decode a SIB1. Such scenarios may occur, for example, in non-line of sight (nLOS) scenarios between the UE and the non-terrestrial (NT) network entity. For example, nLOS scenarios may occur when the UE is located in a user's pocket, a bag, or a vehicle.

An NTN cell may transmit a pre-paging message for which a UE may monitor in a resource based on an SSB and a pre-paging configuration. For example, before a UE enters an RRC inactive mode, the UE may be configured with a pre-paging configuration for one or more NTN cells that may be used to identify an SS and a CORESET in which to monitor for a pre-paging message. In some examples, if the UE receives a pre-paging message, the UE may indicate (e.g., provide an alert) to the user of the UE to move the UE to a line of sight (LOS) scenario. For example, the UE may identify the pre-paging configuration for a specific NTN cell based on identifying a cell identifier (ID) for the NTN cell based on decoding an SSB from the NTN cell. The UE may identify the CORESET and the SS based on the pre-paging configuration and the resource via which the SSB was received. Thus, a UE may receive a pre-paging message from an NTN based on receiving and decoding an SSB even in scenarios where the SINR of the link with the NTN is insufficient to receive SIB1.

Aspects of the disclosure are initially described in the context of wireless communications systems. Aspects of the disclosure are further illustrated by and described with reference to resource diagrams, process flows, apparatus diagrams, system diagrams, and flowcharts that relate to pre-paging monitoring for NTNs.

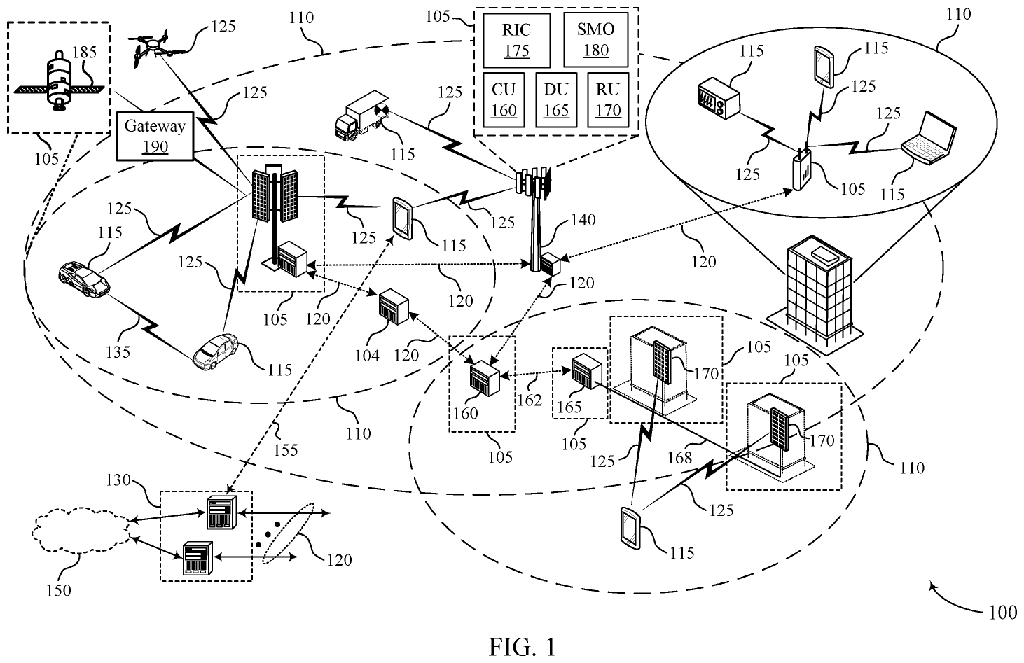

FIG. 1 shows an example of a wireless communications system 100 that supports pre-paging monitoring for NTNs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support pre-paging monitoring for NTNs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information (SI)), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more SS sets, and each SS set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. SS sets may include common SS sets configured for sending control information to multiple UEs 115 and UE-specific SS sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an ID for distinguishing neighboring cells (e.g., a physical cell ID (PCID), a virtual cell ID (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a network entity 105 may refer to a terrestrial communication device (such as a base station 140) or a non-terrestrial communication device (such as a satellite 185, a balloon, a drone, a UAS platform, or another non-terrestrial device). An NT network entity 105 may be connected to a terrestrial network entity 105 via a gateway 190. In some examples, an NT network entity 105 may correspond to a first cell type (e.g., a non-terrestrial network cell type), and a terrestrial network entity 105 may correspond to a second cell type (e.g., a terrestrial network cell type) different from the first cell type.

A non-terrestrial network may refer to a network, or one or more segments of networks using RF resources for communications between a UE 115 and a satellite 185 or an unmanned aerial system (UAS) platform. For instance, a UE 115 may communicate with an NT network entity 105 (e.g., a satellite 185 or another non-terrestrial device) via a service link (e.g., a communication links 125), and the NT network entity 105 may be connected to a gateway 190 (e.g., an NTN gateway) via a feeder link (e.g., a backhaul communication link 120). The gateways may be co-located with or in communication with another network entity 105 (e.g., a terrestrial network entity 105 such as a base station 140) and signaling may be communicated between the network entity 105 and the UE 115 via the gateway 190 and the NT network entity 105. An NTN cell may be associated with respective non-terrestrial network entities 105, and each NT network entity 105 may be associated with one or more gateways 190.

In some scenarios, for example, when a UE 115 is located in a remote location, the UE 115 may be served by an NTN (e.g., an NT network entity 105 such as a satellite). In such scenarios, the NTN may transmit and the UE 115 may monitor for short messages when the UE 115 is camped on an NTN cell in an RRC idle or RRC inactive mode with the NTN cell. Messages transmitted by NTNs, such as paging messages, may be used for public safety or emergency purposes, and thus missed paging messages may be detrimental to public safety or emergency awareness. For example, paging messages may be transmitted via a DCI for safety or emergency purposes or to indicate an incoming SMS or voice call to the UE 115. For example, short messages may be transmitted with a paging radio network temporary identifier (P-RNTI) via DCI. Short messages may be transmitted on PDCCH using a P-RNTI with or without an associated paging message using a short message field in DCI format 1_0. For example, DCI format 1_0 may include the fields shown in Table 1.

TABLE 1

| Field | Bits |
|---|---|
| Short message indicator field | 2 |
| Short Messages | 8 |
| Frequency Domain Resource Assignment | Variable |
| (FDRA) | |
| Time Domain Resource Assignment | 4 |
| (TDRA) | |
| Virtual Resource Block (VRB) to | 1 |
| Physical Resource Block (PRB) Mapping | |
| Modulation and Coding Scheme (MCS) | 5 |
| Transport Block Scaling | 2 |
| Reserved | 6 |

Table 2 shows example short message indicators for different values for the short message indicator field for a DCI having DCI format 1_0.

TABLE 2

| Value | Short Message Indicator |
|---|---|
| 00 | Reserved |
| 01 | Only scheduling information for paging, and tracking reference |
| | signal (TRS) availability indication if the higher layer parameter |
| | trsResourceSetConfig is configured, are present in the DCI. |
| 10 | Only short message, and TRS availability indication if the higher |
| | layer parameter trs-ResourceSetConfig is configured, are present in |
| | in the DCI. |
| 11 | Both scheduling information for Paging and TRS availability |
| | indication if the higher layer parameter trsResourceSetConfig is |
| | configured and short message are present in the DCI. |

Table 3 shows example short messages that may be indicated by the 8-bit short message field in DCI format 1_0. The short message field in DCI format 1_0 may be set as reserved when the short message indicator field is set to “01.”

TABLE 3

| Bit | Short Message |
|---|---|
| 1 | SystemInfoModification. If set to “1”, may indicate a broadcast |
| | control channel (BCCH) modification other than SIB1, SIB7, SIB8, |
| | and posSIBs. |
| 2 | etwsAndCmasIndication. If set to “1”, may indicate an earthquake |
| | and tsunami warning system (ETWS) primary notification and/or an |
| | ETWS secondary notification and/or a commercial mobile alert |
| | system (CMAS) notification. |
| 3 | stopPagingMonitoring. This bit may be used for only operation with |
| | shared spectrum channel access if the parameter nrofPDCCH- |
| | MonitoringOccasionPerSSB-inPO is present in the DCI. If set to “1”, |
| | may indicate that the UE may stop monitoring PDCCH occasions for |
| | paging in this paging occasion. |
| 4 | systemInfoModification-eDRX. If set to 1: may indicate a BCCH |
| | modification other than SIB6, SIB7, SIB8 and posSIBs. This |
| | indication may apply only to UEs using an idle enhanced |
| | discontinuous reception (eDRX) cycle longer than the BCCH |
| | modification period. |
| 5-8 | Reserved and ignored by UE |

The FDRA field may be variable with the quantity of resource blocks configured for the active downlink BWP. For example, the quantity of bits for the FDRA in the DCI format 1_0 may be given by

$$[ {log}_{2} ( \frac{{N}_{RB}^{DL , BWP} ( {N}_{RB}^{DL \cdot BWP} + 1 )}{2} ) ] ,$$

where N_{RB}^{DL,BWP} indicates the size of CORESET 0 in terms of resource blocks. The TDRA field may indicate the row index of items in the RRC parameter pdsch_allocationList. The VRB to BRB field may have a value “0” to indicate non-interleaved and a value “1” to indicate interleaved. The MCS field may indicate an MCS for a physical downlink shared channel (PDSCH) scheduled by the DCI format 1_0. In some examples, a DCI format 1_0 may include an indication of a paging cause.

During initial network access, a UE 115 may complete a band scan for an SSB transmitted by an NTN cell and may decode the PBCH included in a received SSB. The PBCH may provide information that enables the UE 115 to proceed to decode a SIB1. The SIB1 may be transmitted on a PDSCH scheduled by a PDCCH (e.g., in DCI format 1_0). For example, the scheduling information for a SIB1 may be included in DCI format 1_0, and the DCI format 1_0 may be transmitted in a PDCCH monitoring occasion corresponding to a CommonSearchSpaceType0. The MIB in the PBCH may indicate the CORESET (referred to as CORESET #0) and CommonSearchSpaceType0 (referred to as SearchSpace #0) for the monitoring occasion which will include the DCI format 1_0 that will include the scheduling information for the SIB1. For example, the MIB may provide an information element (IE) pdcch-ConfigSIB1 which includes an indication of the CORESET #0 and the SearchSpace #0. The IE pdcch-ConfigSIB1 may include 8 bits. The UE 115 may determine that a CORESET #0 for a Type #0-PDCCH common SS is present if Kssb<=23 for frequency range 1 (FR1) and if Kssb is <=11 for frequency range 2 (FR2), where Kssb refers to the frequency of resource block (RB) #0 for the SSB, and the unit for Kssb is expressed as 15 kHz for FR1 and 60 kHz for FR2. The UE 115 may determine that a CORESET #0 for a Type #0-PDCCH common SS is not present if Kssb>23 (FR1) and Kssb>11 for FR2. The first four bits (most significant bits (MSBs)) of the IE pdcch-ConfigSIB1 may determine the controlResourceSetZero index. The last four bits (least significant bits (LSBs)) of the IE searchSpaceZero may determine the SearchSpace #0 index. The indicated controlResourceSetZero IE indicates the quantity of RBs or symbols used to determine the CORESET size of the Type #0 common SS. The CORESET bandwidth may be 24, 48, or 96 RBs and the CORESET durations may be 1, 2, or 3 symbols. The indicated searchSpaceZero IE indicates the PDCCH monitoring occasions (e.g., the SFN and the slot information for the UE to monitor for the Type #0 common SS.

For outgoing calls, a user of a UE 115 in a remote location may consciously choose a good spot to initiate communications, for example, a spot with an LOS to the satellite (e.g., no overhead coverage). For incoming service via NTN, users may experience poor reception conditions and thus may miss calls and messages. For example, a UE 115 served by an NTN may be located in a user's pocket, in a bag, or in a vehicle or boat. For example, UEs 115 in suburban and rural scenarios may be affected by shadow fading and clutter loss, and the NLOS due to clutter loss can be over 18 dBs. For example, at 30 degrees elevation, approximately 10 percent of users in rural scenarios and 50 percent of users in urban areas may experience NLOS with respect to an NTN.

Decoding of SIB1 may demand a higher SINR than SSBs, as SIB1 may be more information-intensive than SSBs. Accordingly, in low SINR scenarios, a UE 115 may be able to receive and decode SSBs from an NTN in order to obtain SSB synchronization with an NTN cell, but the UE 115 may not be able to camp on any NTN cell (e.g., the NTN cell selection criteria may not be met and the UE 115 may be unable to decode an SIB1 from the NTN cell). As SIB1 may include an indication of a CORESET and SS for reception of paging messages, a UE 115 may not be able to receive paging messages if the UE 115 cannot receive and/or decode SIB1.

In such low SINR scenarios, a UE 115 may monitor for and receive pre-paging messages from the NTN cell. For example, a pre-paging channel may include a self-contained PDCCH, whereas to receive a legacy paging message, the UE 115 may monitor a paging PDCCH in a paging CORESET and SS indicated by SIB1 in order to receive a paging PDCCH (e.g., DCI format 1_0 scrambled by P-RNTI) which schedules a PDSCH carrying a paging message. Accordingly, a legacy paging message may be carried by a PDSCH and may be scheduled by a DCI format 1_0.

Before a UE 115 enters an RRC inactive mode, the UE 115 may be configured with a pre-paging configuration for one or more NTN cells that may be used to identify an SS and a CORESET in which to monitor for a pre-paging message. In some examples, if the UE receives a pre-paging message, the UE 115 may indicate (e.g., provide an alert) to the user of the UE 115 to move the UE 115 to an LOS scenario. For example, the UE 115 may identify the pre-paging configuration for a specific NTN cell based on identifying a cell ID for the NTN cell based on decoding an SSB from the NTN cell. The UE 115 may identify the CORESET and the SS based on the pre-paging configuration and the resource via which the SSB was received. Thus a UE 115 may receive a pre-paging message from an NTN based on receiving and decoding an SSB even in scenarios where the SINR of the link with the NTN is insufficient to receive SIB1.

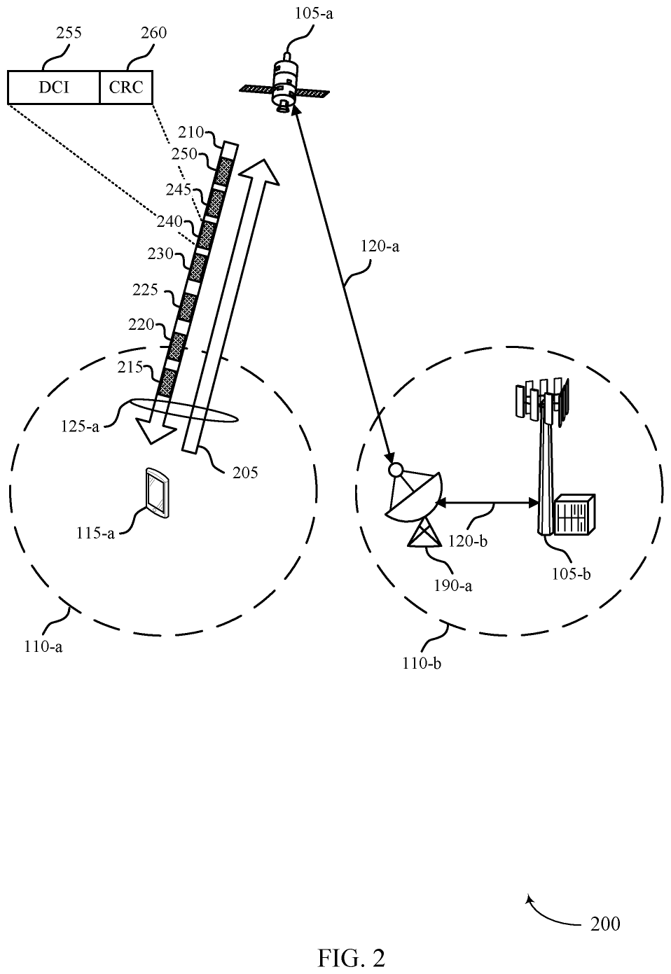

FIG. 2 shows an example of a wireless communications system 200 that supports pre-paging monitoring for NTNs in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a and a network entity 105-b, which may be examples of network entities 105 as described herein. In some cases, the network entity 105-a may be an example of an NT network entity 105 (e.g., a non-terrestrial network cell), and may be connected to a gateway 190-a, which may be an example of a gateway 190 as described herein with reference to FIG. 1.

The network entity 105-a may be associated with a coverage area 110-a, and the network entity 105-b may be associated with a coverage area 110-b. The UE 115-a may communicate with the network entity 105-a using a communication link 125-a. The communication link 125-a may be an example of an NR or LTE link between the UE 115-a and the network entity 105-a. The communication link 125-a may include a bi-directional link that enable both uplink and downlink communications. For example, the UE 115-a may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-a using the communication link 125-a. In some examples, the network entity 105-a may communicate with the gateway 190-a via a backhaul communication link 120-a, and the network entity 105-b may communicate with the gateway via a backhaul communication link 120-b, which may be examples of backhaul communication links 120 as described herein. For example, the network entity 105-a may communicate with the core network 130 via the backhaul communication link 120-a and the gateway 190-a.

As shown, the UE 115-a may be located in a location that is within the coverage area 110-a served by the network entity 105-a. For example, the UE 115-a may be located on the ocean or in a rural or remote location and may not be served by a terrestrial network entity (e.g., the network entity 105-b). The network entity 105-a may transmit paging messages 250 via PDSCH. As described herein, to receive paging messages 250, the UE 115-a first decodes an SSB 215 and the MIB included in the PBCH of the SSB 215. The MIB may indicate an SS (SearchSpace #0) and CORESET (CORESET #0) for reception of a DCI 220 of DCI format 1_0, where the DCI 220 indicates the scheduling information for reception of a SIB1 225. The SIB1 225 may indicate a paging CORESET and a paging SS which to monitor for a PDCCH which conveys a DCI 245 which schedules the paging message 250.

In some scenarios, the communication link 125-a between the UE 115-a and the network entity 105-a may have a sufficient SINR to enable the UE 115-a to receive and decode an SSB 215 but may not have a sufficient SINR to enable the UE 115-a to receive and decode a SIB1 225 to camp on a cell of the network entity 105-a and receiving paging messages 250. For example, the UE 115-a may be in an NLOS scenario with respect to the network entity 105-a. Accordingly, in some examples, the network entity 105-a may transmit a pre-paging message 240 to the UE 115-a. In some examples, a pre-paging message 240 may trigger an alert to a user of the UE 115-a such that the user may consciously choose a good spot for communications with the network entity (e.g., an area without overhead blockages for the UE 115-a). For example, the UE 115-a may pass information in the pre-paging message 240 to higher layers of the UE 115-a to trigger an alert. For example, in response to an alert, a use of the UE 115-a may move to a higher SINR location (e.g., without overhead blockages) in order to connect to the cell and/or be able to receive and decode the paging messages 250.

In some examples, the network entity 105-a may identify a pre-paging ID for the UE 115-a, for example, from the core network 130 as described herein (e.g., via the backhaul communication link 120-a and the gateway 190-a). For example, the pre-paging ID for the UE 115-a may be obtained by the network entity 105-a from the core network 130 during a pre-paging request or a registration request, may be derived by the network entity 105-a from information provided by the core network 130 in a paging request, or may be identified by the network entity 105-a from an inactive radio network temporary identifier (I-RNTI) for the UE 115-a. In each case, the UE 115-a may have the pre-paging ID for the UE 115-a stored at the UE. The pre-paging message 240 may be a DCI 255 with cyclic redundancy check (CRC) 260 (e.g., CRC XOR bits) appended to the DCI 255. The DCI 255 may indicate a paging cause (e.g., incoming voice call, incoming SMS message, incoming data, emergency call, or public warning) and may include the pre-paging ID for the UE 115-a (or at least a portion of the pre-paging ID for the UE 115-a). In some examples, the RRC layer of the UE 115-a may pass the information conveyed in the pre-paging message 240 to an upper layer of the UE 115-a. For example, the upper layer may display and/or sound an alert that can be viewed or listened to by a user of the UE 115-a that may indicate the paging cause indicated in the pre-paging message 240. In some examples, the pre-paging ID for the UE 115-a may be split into two portions, where the first portion may be indicated in the DCI 255 and the second portion may be used to scramble the bits of the CRC 260.

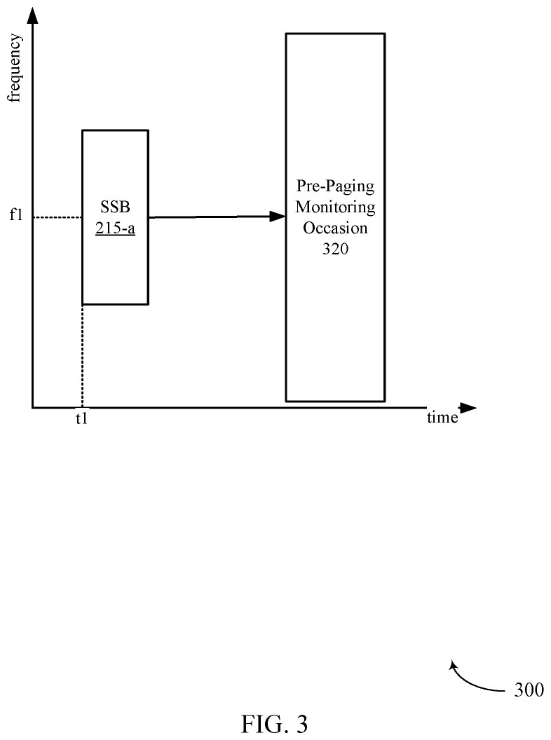

The UE 115-a may identify the resource to monitor (e.g., the PDDCH monitoring occasion) for reception of the pre-paging message 240 based on reception of an SSB 215 and a pre-paging configuration associated with the network entity 105-a. For example, while in an RRC connected mode with the network entity 105-a, the UE 115-a may receive control signaling 230 indicating a pre-paging configuration for the network entity 105-a. For example, the pre-paging configuration may indicate a position in a time domain (e.g., an SS indicating which radio frame, subframe, or slot) to monitor for a pre-paging message 240. For example, for the indicated SS, the pre-paging configuration may configure a new SS or may indicate to use SearchSpace #0 indicated in the MIB. The pre-paging configuration may indicate a position in the frequency domain (e.g., a CORESET). The position in the frequency domain may be indicated relative to the frequency of the SSB 215, for example, as described with reference to FIG. 3. The pre-paging configuration also may indicate a quantity of RBs (e.g., a bandwidth of the CORESET), a quantity of symbols per CORESET, a starting symbol number, a repetition pattern (e.g., indicating of PDCCH repetition is supported, and if yes, which repetition pattern, such as intra-slot, across symbols, or inter slot), an aggregation level (AL), and/or a quantity of candidate CORESETs. Absent an explicit indication of any of the listed parameters in the pre-paging configuration, the UE 115-a may assume, for the absent parameter, a same configuration as the configuration for CORESET #0 indicated by the MIB.

In some examples, the control signaling 230 may be broadcast (e.g., in SI). In some examples, the control signaling 230 may be unicast to the UE 115-a, for example, in an RRC message. In some examples, the UE 115-a may receive the control signaling 230 from another network entity 105, such as the network entity 105-b when the UE 115-a was in the coverage area 110-b and in an RRC connected mode with the network entity 105-b. For example, network entities 105 may indicate a pre-paging configuration list for themselves and/or for other cells or network entities 105. For example, the network entity 105-a, the network entity 105-b, or another network entity 105 may determine a list of cells for which to provide pre-paging configurations, and may transmit the control signaling 230 indicating the pre-paging configurations for the list of cells (e.g., including the network entity 105-a). The UE 115-a may store the indicated pre-paging configuration(s) in memory, thus enabling reception of pre-paging messages in deep coverage scenarios (e.g., in low SINR scenarios where the UE 115-a is served by an NTN). The pre-paging configurations may each be associated with a respective cell ID, and the UE 115-a may identify a cell, and thus the appropriate pre-paging configuration based on decoding an SSB (e.g., the SSB 215).

In some examples, the pre-paging CORESET and the pre-paging SS may inherit some properties of CORESET #0 and/or SearchSpace #0 to reduce signaling associated with pre-paging. As an example, SearchSpace #0 indicated by a MIB may be used for monitoring pre-paging (e.g., no additional SS may be configured for pre-paging messages), but the network may provide a different CORESET from the CORESET #0 for pre-paging messages (e.g., indicated in a pre-paging configuration as a starting position relative to an SSB, a duration, a bandwidth, an AL, and a repetition pattern). In some examples, a pre-paging configuration may be common across some cells. In some examples, pre-paging configurations may be cell-specific. In some examples, a pre-paging configuration may be common across all cells, an in such cases, the network may indicate in the control signaling the cells (e.g., by cell ID) that support pre-paging.

In some examples, the network entity 105-a may indicate in a SSB 215 that the network entity 105-a (e.g., the cell associated with the network entity 105-a) supports pre-paging and the UE may determine the CORESET and SS to monitor for pre-paging messages based on the indication that the network entity 105-a supports pre-paging. For example, a bit in the MIB in the SSB 215 may be used to indicate whether the network entity 105-a supports pre-paging. If the network entity 105-a indicates that the network entity 105-a does not support pre-paging, the UE 115-a may not determine the CORESET and SS to monitor for pre-paging messages and/or may not monitor for pre-paging messages from the network entity 105-a (e.g., based on the cell ID associated with the network entity 105-a determined from decoding the SSB 215). In some examples, based on receiving an indication that the network entity 105-a does not support pre-paging (e.g., in a MIB in an SSB 215), the UE 115-a may clear a pre-paging configuration associated with the cell ID associated with the network entity 105-a that is stored in memory of the UE 115-a. In some examples, the network entity 105-a may temporarily disable pre-paging, and may indicate the disabling of pre-paging in a MIB in an SSB 215.

FIG. 3 shows an example of a resource diagram 300 that supports pre-paging monitoring for NTNs in accordance with one or more aspects of the present disclosure. The resource diagram 300 may implement or may be implemented by aspects of the wireless communications system 100 or the wireless communications system 200.

As described herein, a pre-paging configuration may indicate a PDCCH monitoring occasion 320 (e.g., a CORESET and an SS) for pre-paging message in respect to the resources at which an SSB was received. For example, when a UE 115 receives an SSB 215-a from an NTN cell at time t1 and with a middle frequency of f1, the UE 115 may identify the pre-paging configuration associated with the cell ID indicated by the SSB 215-a. The UE 115 may calculate the time and frequency location of the PDCCH monitoring occasion 320 for a pre-paging message from the NTN cell associated with the cell ID relative to the time (t1) and frequency (e.g., f1) of the SSB 215-a using the identified pre-paging configuration associated with the cell ID indicated by the SSB 215-a,

The procedure the UE 115 uses to determine the PDCCH monitoring occasion 320 for a pre-paging message (e.g., the pre-paging message 240 as described with reference to FIG. 2) may be different than the procedure for determining the monitoring occasion for a paging message, which may by scheduled by a DCI received in a paging SS and CORESET, where the paging SS and CORESET may be indicated by SIB1. As the UE 115 may perform pre-paging monitoring at low SINR scenarios, the location of the PDCCH monitoring occasion 320 for the pre-paging message may be configured with respect to the SSB location. This procedure may be similar to the determination of CORESET #0 and SearchSpace #0 which are extracted from the MIB in the PBCH in the SSB, but the PDCCH monitoring occasion 320 for the pre-paging message may be determined based on a pre-paging configuration stored previously indicated by the network and stored in memory of the UE 115 as applied to the SSB location.

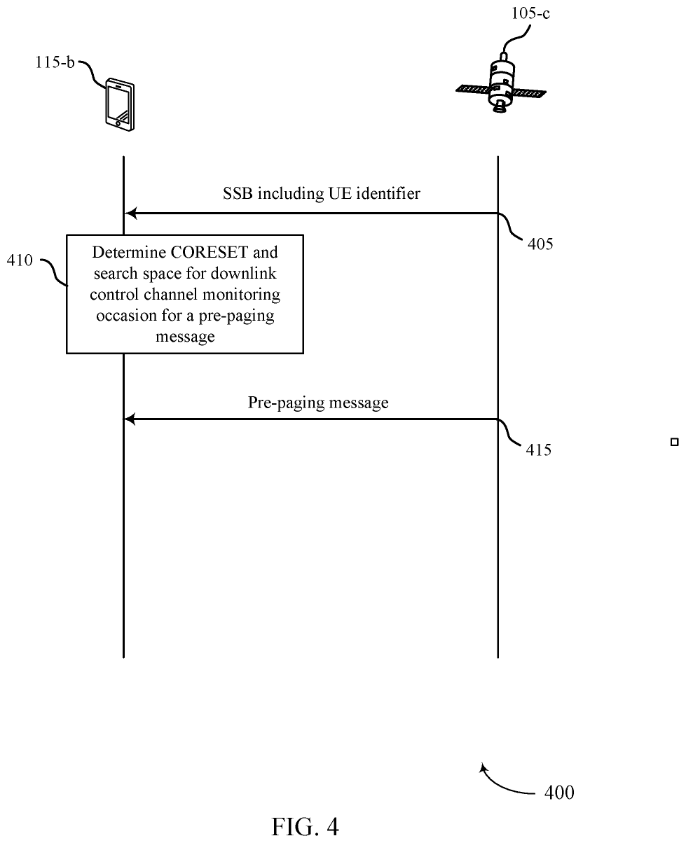

FIG. 4 shows an example of a process flow 400 that supports pre-paging monitoring for NTNs in accordance with one or more aspects of the present disclosure. The process flow 400 may include a UE 115-b, which may be an example of a UE 115 as described herein. The process flow 400 may include a network entity 105-c, which may be an example of a network entity 105 as described herein. For example, the network entity 105-c may be an example of an NT network entity 105 as described herein. In the following description of the process flow 400, the operations between the network entity 105-c and the UE 115-b may be transmitted in a different order than the example order shown, or the operations performed by the network entity 105-c and the UE 115-b may be performed in different orders or at different times. Some operations may also be omitted from the process flow 400, and other operations may be added to the process flow 400.

At 405, the UE 115-b may receive, from the network entity 105-c while in an RRC idle mode or an RRC inactive mode, an SSB. The SSB may be indicative of a cell ID of the network entity 105-c.

At 410, the UE 115-b may determine, based on the cell ID, an SS and a CORESET for a downlink control channel monitoring occasion (e.g., a PDCCH monitoring occasion) for a pre-paging message from the network entity 105-c.

For example, before receiving the SSB at 405, the UE 115-b may receive control signaling from the network entity 105-c or another network entity 105, while the UE 115-a was in an RRC connected mode with the network entity 105-c or another network entity 105. The control signaling may indicate a pre-paging configuration associated with the cell ID of the network entity 105-c. For example, the UE 115-b may determine the CORESET and the SS for the downlink control channel monitoring occasion based on the pre-paging configuration associated with the cell ID and the communication resources via which the SSB was received at 405. For example, the UE 115-b may determine the CORESET for the downlink control channel monitoring occasion based on the pre-paging configuration (e.g., indicating a frequency offset or a middle or starting frequency with respect to the SSB) and the frequency resources at which the SSB was received at 405. As another example, the UE 115-b may determine the SS for the downlink control channel monitoring occasion based on the pre-paging configuration and the timing of the SSB. For example, the UE 115-b may determine the cell ID of the network entity 105-c based on decoding the SSB at 405 and may accordingly identify the pre-paging configuration to apply based on the determined cell ID. In some examples, the control signaling may indicate a set of multiple pre-paging configurations associated with a set of multiple respective cell IDs, and the set of multiple pre-paging configurations includes the pre-paging configuration ID at 410, and the set of multiple respective cell IDs includes the cell ID associated with the network entity 105-c. In some examples, the control signaling may be received via SI. In some examples, the control signaling may be received via a unicast RRC message.

In some examples, before receiving the SSB at 405, the UE 115-b may receive control signaling from the network entity 105-c or another network entity 105 that indicates a CORESET configuration associated with a set of cell IDs, where the set of cell IDs includes the cell ID identified in the SSB, and the UE identifies the CORESET for the downlink control channel monitoring at 410 based on a frequency resource via which the SSB is received at 405 and the CORESET configuration. In such examples, the UE 115-b may receive a MIB from the network entity 105-c (e.g., in the SSB at 405) that indicates the SS for the downlink control channel monitoring occasion.

At 415, the UE 115-b may receive, from the network entity 105-c via the downlink control channel monitoring occasion, the pre-paging message, where the pre-paging message includes a UE ID. In some examples, the pre-paging message may indicate a paging cause. In some examples, the pre-paging message may be received via a DCI with a CRC scrambled by a second part of a pre-paging ID for the UE 115-b, and the UE ID in the pre-paging message may be a first part of the pre-paging ID for the UE 115-b. In some examples, before receiving the SSB at 405, the UE 115-b may receive control signaling from the network entity 105-c or another network entity 105 that indicates the pre-paging ID for the UE 115-b.

In some examples, the UE 115-b may enter a pre-paging monitoring mode based on determining that the UE 115-b is in a low coverage scenario (e.g., based on determining that the SINR of the communication link with the network entity 105-c is below a threshold level). For example, if the UE 115-b determines that the UE 115-b is not in a low coverage scenario (e.g., the SINR of the communication link with the network entity 105-c is at or above the threshold level), the UE 115-b may monitor for paging messages from the network entity 105-c (e.g., paging messages 250 as describe with reference to FIG. 2) and may not monitor for pre-paging messages. If the UE 115-b determines that the UE 115-b is in a low coverage scenario (e.g., based on determining that the SINR of the communication link with the network entity 105-c is below a threshold level), the UE 115-b may determine if the UE 115-b is in a location inside a zone extracted from a pre-paging ID signaled by the core network or a network entity when the UE was not in a low coverage scenario. If the UE 115-b is not inside the zone extracted from a pre-paging ID, the UE 115-b may not monitor for pre-paging messages. If the UE 115-b is inside the zone extracted from a pre-paging ID, the UE 115-b may monitor for and detect the SSB at 405, extract the cell ID from the SSB, and determine the pre-paging configuration associated with the extracted cell ID.

In some examples, the SSB at 405 may include (e.g., in a MIB in the SSB) an indication that the network entity 105-c supports pre-paging. In such examples, the UE 115-b may determine, at 410, the SS and the CORESET based on the indication that the network entity 105-c supports pre-paging.

In some examples, the UE 115-b may receive, from a second NT network entity 105 (e.g., when located in another coverage area) a second SSB including an indication (e.g., in a MIB in the second SSB) that the second NT network entity does not support pre-paging. The second SSB may be indicative of a second cell ID of the second NT network entity. The UE 115-b may refrain from determining a second SS and a second CORESET for monitoring pre-paging messages from the second NT network entity 105 based on receiving the indication that the second NT network entity does not support pre-paging.

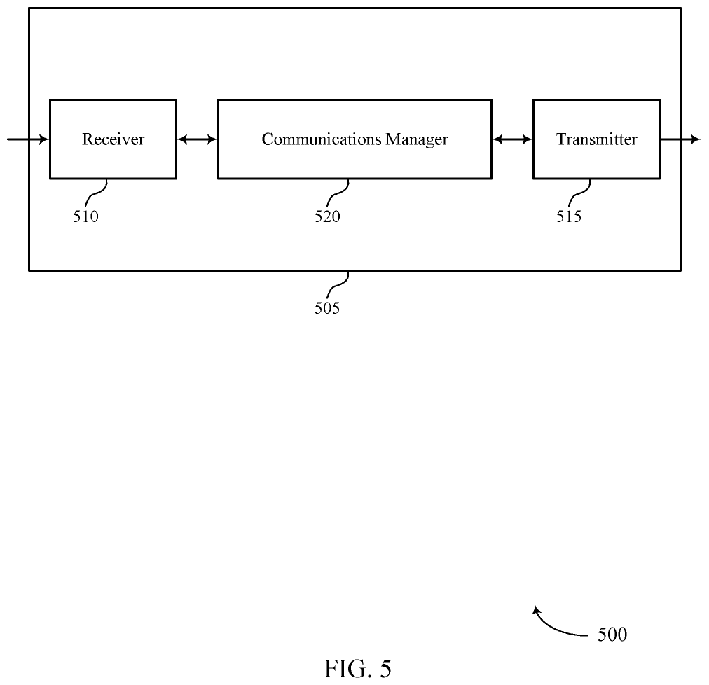

FIG. 5 shows a block diagram 500 of a device 505 that supports pre-paging monitoring for NTNs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to pre-paging monitoring for NTNs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to pre-paging monitoring for NTNs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of pre-paging monitoring for NTNs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from an NT network entity while in an RRC idle mode or an RRC inactive mode, an SSB, where the SSB is indicative of a cell ID of the NT network entity. The communications manager 520 is capable of, configured to, or operable to support a means for determining, based on the cell ID, an SS and a CORESET for a downlink control channel monitoring occasion for a pre-paging message from the NT network entity, where the pre-paging message includes a UE ID. The communications manager 520 is capable of, configured to, or operable to support a means for receiving, from the NT network entity via the downlink control channel monitoring occasion, the pre-paging message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

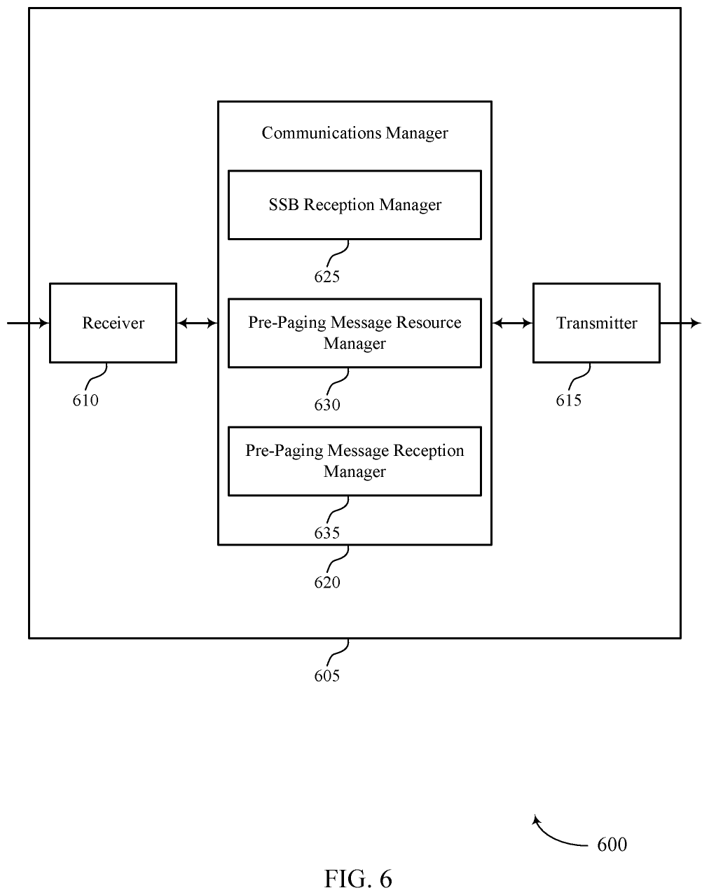

FIG. 6 shows a block diagram 600 of a device 605 that supports pre-paging monitoring for NTNs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to pre-paging monitoring for NTNs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to pre-paging monitoring for NTNs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of pre-paging monitoring for NTNs as described herein. For example, the communications manager 620 may include an SSB reception manager 625, a pre-paging message resource manager 630, a pre-paging message reception manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SSB reception manager 625 is capable of, configured to, or operable to support a means for receiving, from an NT network entity while in an RRC idle mode or an RRC inactive mode, an SSB, where the SSB is indicative of a cell ID of the NT network entity. The pre-paging message resource manager 630 is capable of, configured to, or operable to support a means for determining, based on the cell ID, an SS and a CORESET for a downlink control channel monitoring occasion for a pre-paging message from the NT network entity, where the pre-paging message includes a UE ID. The pre-paging message reception manager 635 is capable of, configured to, or operable to support a means for receiving, from the NT network entity via the downlink control channel monitoring occasion, the pre-paging message.

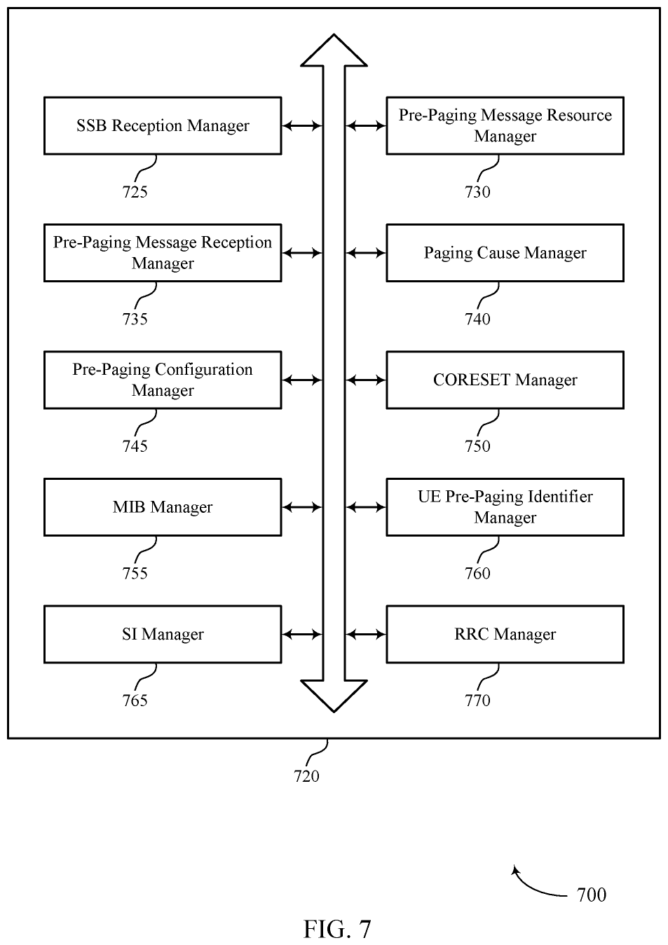

FIG. 7 shows a block diagram 700 of a communications manager 720 that supports pre-paging monitoring for NTNs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of pre-paging monitoring for NTNs as described herein. For example, the communications manager 720 may include an SSB reception manager 725, a pre-paging message resource manager 730, a pre-paging message reception manager 735, a paging cause manager 740, a pre-paging configuration manager 745, a CORESET manager 750, a MIB manager 755, a UE pre-paging ID manager 760, an SI manager 765, an RRC manager 770, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SSB reception manager 725 is capable of, configured to, or operable to support a means for receiving, from an NT network entity while in an RRC idle mode or an RRC inactive mode, an SSB, where the SSB is indicative of a cell ID of the NT network entity. The pre-paging message resource manager 730 is capable of, configured to, or operable to support a means for determining, based on the cell ID, an SS and a CORESET for a downlink control channel monitoring occasion for a pre-paging message from the NT network entity, where the pre-paging message includes a UE ID. The pre-paging message reception manager 735 is capable of, configured to, or operable to support a means for receiving, from the NT network entity via the downlink control channel monitoring occasion, the pre-paging message.

In some examples, to support receiving the pre-paging message, the paging cause manager 740 is capable of, configured to, or operable to support a means for receiving, in the pre-paging message, an indication of a paging cause.

In some examples, to support receiving the pre-paging message, the pre-paging message reception manager 735 is capable of, configured to, or operable to support a means for receiving a downlink control information with a cyclic redundancy check scrambled by a second part of a pre-paging ID for the UE, where the UE ID is a first part of the pre-paging ID for the UE.

In some examples, the UE pre-paging ID manager 760 is capable of, configured to, or operable to support a means for receiving, from the NT network entity or another network entity prior to reception of the SSB, an indication of the pre-paging ID for the UE.

In some examples, the pre-paging configuration manager 745 is capable of, configured to, or operable to support a means for receiving, from the NT network entity or another network entity prior to reception of the SSB, an indication of a pre-paging configuration associated with the cell ID, where determining the SS and the CORESET is based on the pre-paging configuration.

In some examples, to support determining the CORESET, the pre-paging message resource manager 730 is capable of, configured to, or operable to support a means for determining the CORESET based on a frequency resource via which the SSB is received.

In some examples, to support receiving the indication of the pre-paging configuration, the pre-paging configuration manager 745 is capable of, configured to, or operable to support a means for receiving an indication of a set of multiple pre-paging configurations associated with a set of multiple respective cell IDs, where the set of multiple pre-paging configurations includes the pre-paging configuration, and where the set of multiple respective cell IDs includes the cell ID.

In some examples, to support receiving the indication of the pre-paging configuration, the SI manager 765 is capable of, configured to, or operable to support a means for receiving SI from the NT network entity or the other network entity that includes the indication of the pre-paging configuration.

In some examples, to support receiving the indication of the pre-paging configuration, the RRC manager 770 is capable of, configured to, or operable to support a means for receiving a unicast RRC message from the NT network entity or the other network entity that includes the indication of the pre-paging configuration.

In some examples, the SSB includes an indication that the NT network entity supports pre-paging, and the UE determines the SS and the CORESET based on the indication that the NT network entity supports pre-paging.

In some examples, the SSB reception manager 725 is capable of, configured to, or operable to support a means for receiving, from a second NT network entity, a second SSB including an indication that the second NT network entity does not support pre-paging, where the second SSB is indicative of a second cell ID of the second NT network entity. In some examples, the pre-paging message resource manager 730 is capable of, configured to, or operable to support a means for refraining, based on the indication that the second NT network entity does not support pre-paging and based on the second cell ID, from determining a second SS and a second CORESET for a second downlink control channel monitoring occasion for a second pre-paging message from the second NT network entity.

In some examples, the CORESET manager 750 is capable of, configured to, or operable to support a means for receiving, from the NT network entity or another network entity prior to reception of the SSB, an indication of a CORESET configuration associated with a set of cell IDs, where the set of cell IDs includes the cell ID, where the CORESET for the downlink control channel monitoring occasion is identified based on a frequency resource via which the SSB is received and the CORESET configuration. In some examples, the MIB manager 755 is capable of, configured to, or operable to support a means for receiving, from the NT network entity, a master information block that indicates the SS.

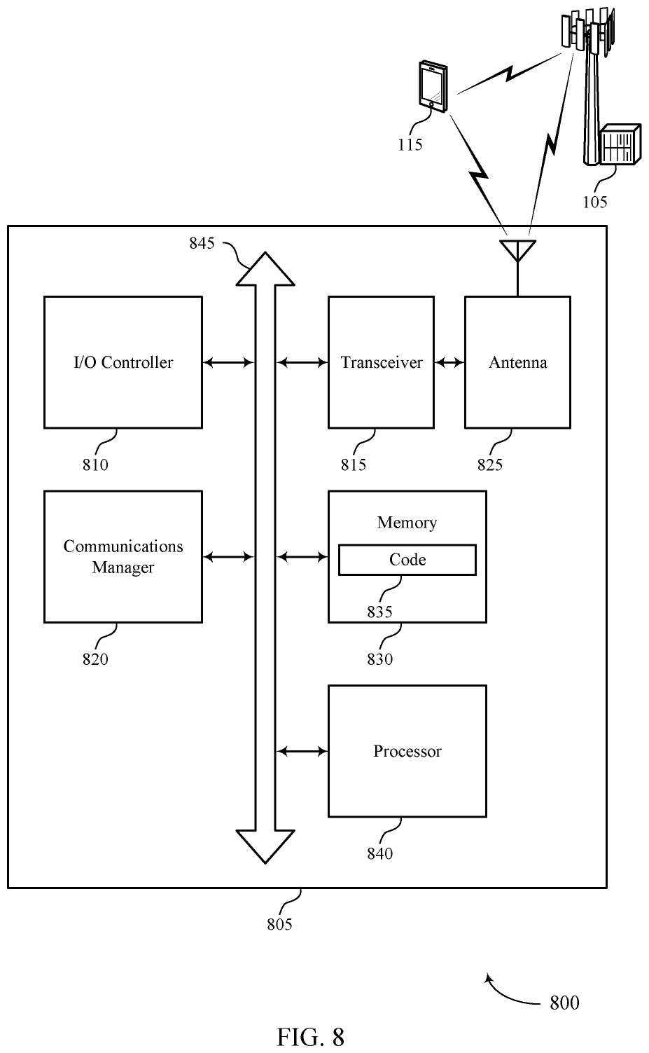

FIG. 8 shows a diagram of a system 800 including a device 805 that supports pre-paging monitoring for NTNs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting pre-paging monitoring for NTNs). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from an NT network entity while in an RRC idle mode or an RRC inactive mode, an SSB, where the SSB is indicative of a cell ID of the NT network entity. The communications manager 820 is capable of, configured to, or operable to support a means for determining, based on the cell ID, an SS and a CORESET for a downlink control channel monitoring occasion for a pre-paging message from the NT network entity, where the pre-paging message includes a UE ID. The communications manager 820 is capable of, configured to, or operable to support a means for receiving, from the NT network entity via the downlink control channel monitoring occasion, the pre-paging message.

By including or configuring the communications manager 820 in accordance with examples as described herein, the device 805 may support techniques for improved communication reliability, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of pre-paging monitoring for NTNs as described herein, or the at least one processor 840 and the at least one memory 830 may be otherwise configured to, individually or collectively, perform or support such operations.

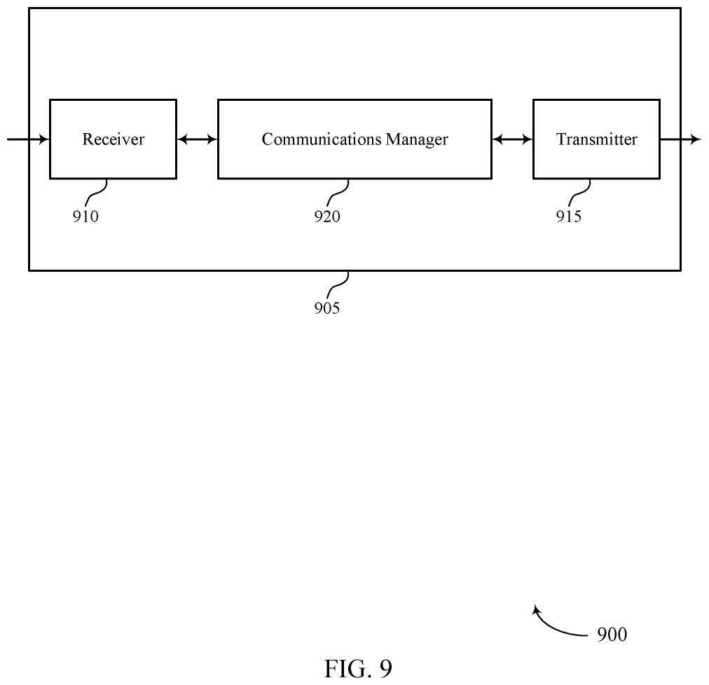

FIG. 9 shows a block diagram 900 of a device 905 that supports pre-paging monitoring for NTNs in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of pre-paging monitoring for NTNs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE in an RRC idle mode or an RRC inactive mode with the NT network entity, an SSB, where the SSB is indicative of a cell ID of the NT network entity. The communications manager 920 is capable of, configured to, or operable to support a means for transmitting, to the UE via a downlink control channel monitoring occasion, a pre-paging message including a UE ID, where an SS and a CORESET for the downlink control channel monitoring occasion are based on the cell ID.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

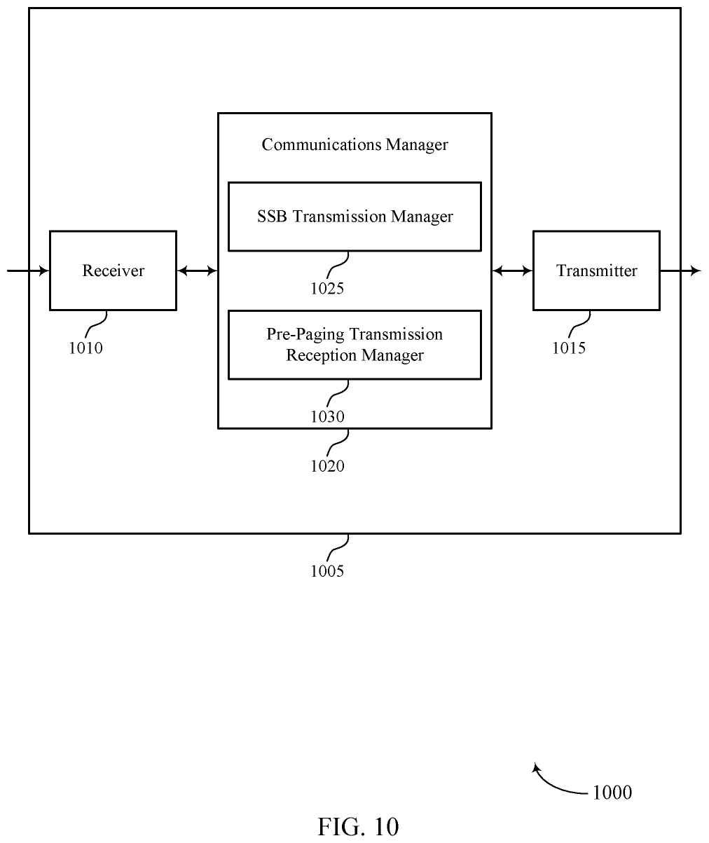

FIG. 10 shows a block diagram 1000 of a device 1005 that supports pre-paging monitoring for NTNs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of pre-paging monitoring for NTNs as described herein. For example, the communications manager 1020 may include an SSB transmission manager 1025 a pre-paging transmission reception manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SSB transmission manager 1025 is capable of, configured to, or operable to support a means for transmitting, to a UE in an RRC idle mode or an RRC inactive mode with the NT network entity, an SSB, where the SSB is indicative of a cell ID of the NT network entity. The pre-paging transmission reception manager 1030 is capable of, configured to, or operable to support a means for transmitting, to the UE via a downlink control channel monitoring occasion, a pre-paging message including a UE ID, where an SS and a CORESET for the downlink control channel monitoring occasion are based on the cell ID.

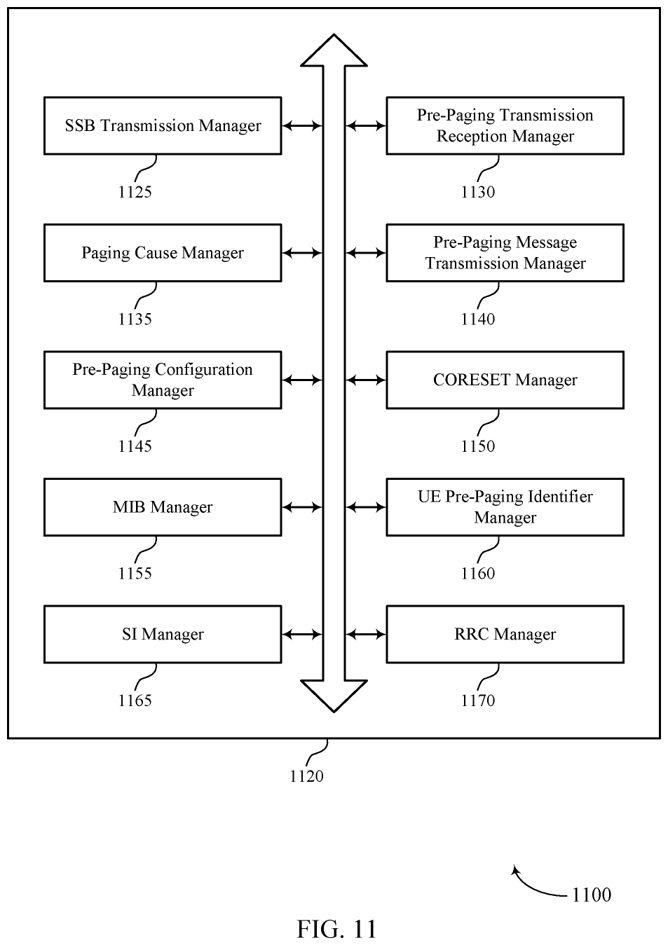

FIG. 11 shows a block diagram 1100 of a communications manager 1120 that supports pre-paging monitoring for NTNs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of pre-paging monitoring for NTNs as described herein. For example, the communications manager 1120 may include an SSB transmission manager 1125, a pre-paging transmission reception manager 1130, a paging cause manager 1135, a pre-paging message transmission manager 1140, a pre-paging configuration manager 1145, a CORESET manager 1150, a MIB manager 1155, a UE pre-paging ID manager 1160, an SI manager 1165, an RRC manager 1170, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The SSB transmission manager 1125 is capable of, configured to, or operable to support a means for transmitting, to a UE in an RRC idle mode or an RRC inactive mode with the NT network entity, an SSB, where the SSB is indicative of a cell ID of the NT network entity. The pre-paging transmission reception manager 1130 is capable of, configured to, or operable to support a means for transmitting, to the UE via a downlink control channel monitoring occasion, a pre-paging message including a UE ID, where an SS and a CORESET for the downlink control channel monitoring occasion are based on the cell ID.

In some examples, to support transmitting the pre-paging message, the paging cause manager 1135 is capable of, configured to, or operable to support a means for transmitting, in the pre-paging message, an indication of a paging cause.

In some examples, to support transmitting the pre-paging message, the pre-paging message transmission manager 1140 is capable of, configured to, or operable to support a means for transmitting a downlink control information with a cyclic redundancy check scrambled by a second part of a pre-paging ID for the UE, where the UE ID is a first part of the pre-paging ID for the UE.

In some examples, the UE pre-paging ID manager 1160 is capable of, configured to, or operable to support a means for transmitting, to the UE prior to transmission of the SSB, an indication of the pre-paging ID for the UE.

In some examples, the pre-paging configuration manager 1145 is capable of, configured to, or operable to support a means for transmitting, to the UE prior to transmission of the SSB, an indication of a pre-paging configuration associated with the cell ID, where the SS and the CORESET for the downlink control channel monitoring occasion are based on the pre-paging configuration.

In some examples, the CORESET for the downlink control channel monitoring occasion is based on a frequency resource via which the SSB is transmitted.

In some examples, to support transmitting the indication of the pre-paging configuration, the pre-paging configuration manager 1145 is capable of, configured to, or operable to support a means for transmitting an indication of a set of multiple pre-paging configurations associated with a set of multiple respective cell IDs, where the set of multiple pre-paging configurations includes the pre-paging configuration, and where the set of multiple respective cell IDs includes the cell ID.

In some examples, to support transmitting the indication of the pre-paging configuration, the SI manager 1165 is capable of, configured to, or operable to support a means for transmitting SI that includes the indication of the pre-paging configuration.

In some examples, to support transmitting the indication of the pre-paging configuration, the RRC manager 1170 is capable of, configured to, or operable to support a means for transmitting a unicast RRC message that includes the indication of the pre-paging configuration.

In some examples, the SSB includes an indication that the NT network entity supports pre-paging.

In some examples, the CORESET manager 1150 is capable of, configured to, or operable to support a means for transmitting, to the UE prior to transmission of the SSB, an indication of a CORESET configuration associated with a set of cell IDs, where the set of cell IDs includes the cell ID, where the CORESET for the downlink control channel monitoring occasion is identified based on a frequency resource via which the SSB is received and the CORESET configuration. In some examples, the MIB manager 1155 is capable of, configured to, or operable to support a means for transmitting, to the UE, a master information block that indicates the SS.

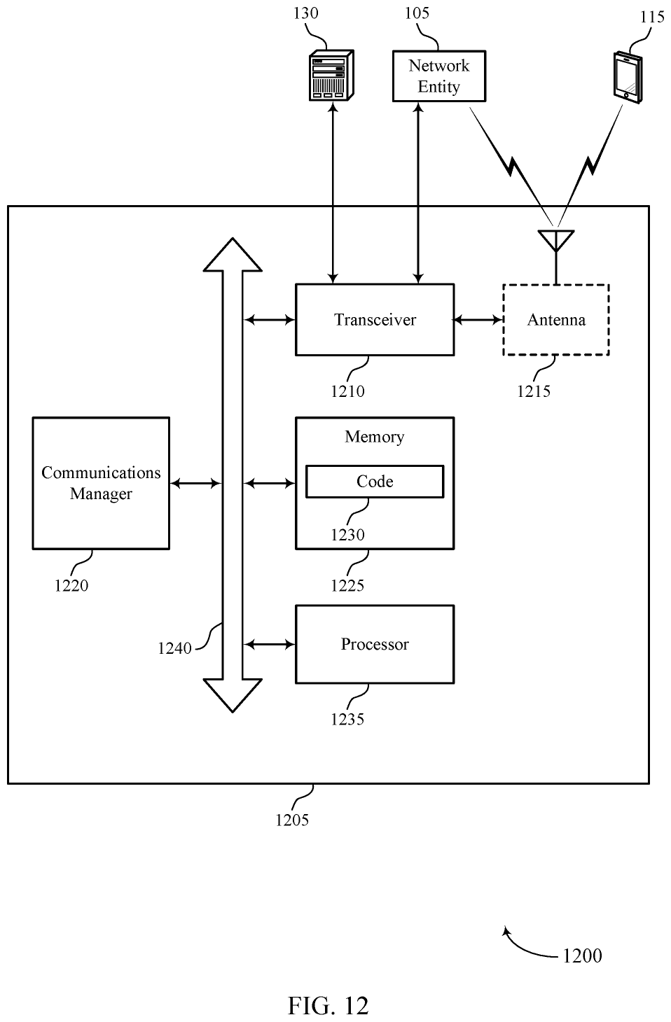

FIG. 12 shows a diagram of a system 1200 including a device 1205 that supports pre-paging monitoring for NTNs in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting pre-paging monitoring for NTNs). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE in an RRC idle mode or an RRC inactive mode with the NT network entity, an SSB, where the SSB is indicative of a cell ID of the NT network entity. The communications manager 1220 is capable of, configured to, or operable to support a means for transmitting, to the UE via a downlink control channel monitoring occasion, a pre-paging message including a UE ID, where an SS and a CORESET for the downlink control channel monitoring occasion are based on the cell ID.

By including or configuring the communications manager 1220 in accordance with examples as described herein, the device 1205 may support techniques for improved communication reliability, reduced power consumption, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of pre-paging monitoring for NTNs as described herein, or the at least one processor 1235 and the at least one memory 1225 may be otherwise configured to, individually or collectively, perform or support such operations.

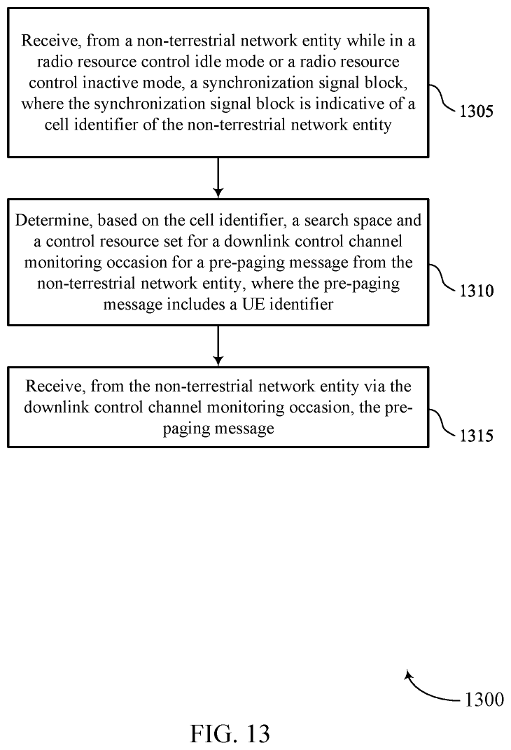

FIG. 13 shows a flowchart illustrating a method 1300 that supports pre-paging monitoring for NTNs in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from an NT network entity while in an RRC idle mode or an RRC inactive mode, an SSB, where the SSB is indicative of a cell ID of the NT network entity. The operations of block 1305 may be performed in accordance with examples as disclosed herein. In some examples, aspects of the operations of 1305 may be performed by an SSB reception manager 725 as described with reference to FIG. 7.

At 1310, the method may include determining, based on the cell ID, an SS and a CORESET for a downlink control channel monitoring occasion for a pre-paging message from the NT network entity, where the pre-paging message includes a UE ID. The operations of block 1310 may be performed in accordance with examples as disclosed herein. In some examples, aspects of the operations of 1310 may be performed by a pre-paging message resource manager 730 as described with reference to FIG. 7.

At 1315, the method may include receiving, from the NT network entity via the downlink control channel monitoring occasion, the pre-paging message. The operations of block 1315 may be performed in accordance with examples as disclosed herein. In some examples, aspects of the operations of 1315 may be performed by a pre-paging message reception manager 735 as described with reference to FIG. 7.

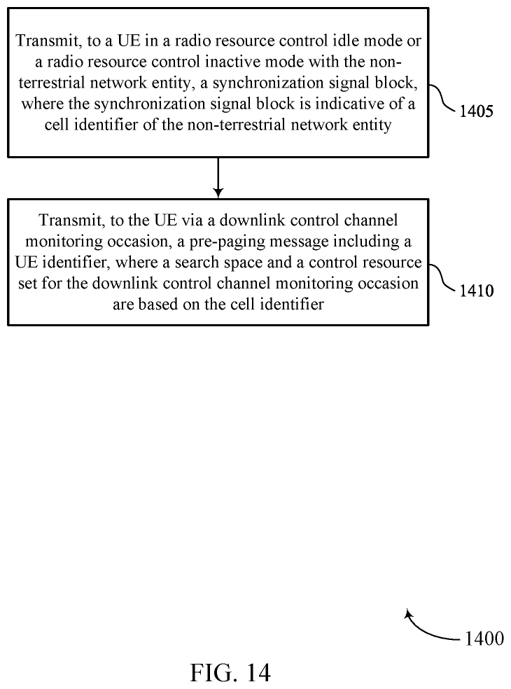

FIG. 14 shows a flowchart illustrating a method 1400 that supports pre-paging monitoring for NTNs in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE in an RRC idle mode or an RRC inactive mode with the NT network entity, an SSB, where the SSB is indicative of a cell ID of the NT network entity. The operations of block 1405 may be performed in accordance with examples as disclosed herein. In some examples, aspects of the operations of 1405 may be performed by an SSB transmission manager 1125 as described with reference to FIG. 11.

At 1410, the method may include transmitting, to the UE via a downlink control channel monitoring occasion, a pre-paging message including a UE ID, where an SS and a CORESET for the downlink control channel monitoring occasion are based on the cell ID. The operations of block 1410 may be performed in accordance with examples as disclosed herein. In some examples, aspects of the operations of 1410 may be performed by a pre-paging transmission reception manager 1130 as described with reference to FIG. 11.

The following provides an overview of aspects of the present disclosure:

Aspect 1: A method for wireless communications at a UE, comprising: receiving, from a NT network entity while in an RRC idle mode or an RRC inactive mode, an SSB, wherein the SSB is indicative of a cell ID of the NT network entity; determining, based at least in part on the cell ID, a SS and a CORESET for a downlink control channel monitoring occasion for a pre-paging message from the NT network entity, wherein the pre-paging message includes a UE ID; and receiving, from the NT network entity via the downlink control channel monitoring occasion, the pre-paging message.

Aspect 2: The method of aspect 1, wherein receiving the pre-paging message further comprises: receiving, in the pre-paging message, an indication of a paging cause.

Aspect 3: The method of any of aspects 1 through 2, wherein receiving the pre-paging message comprises: receiving a downlink control information with a CRC scrambled by a second part of a pre-paging ID for the UE, wherein the UE ID is a first part of the pre-paging ID for the UE.

Aspect 4: The method of aspect 3, further comprising: receiving, from the NT network entity or another network entity prior to reception of the SSB, an indication of the pre-paging ID for the UE.

Aspect 5: The method of any of aspects 1 through 4, further comprising: receiving, from the NT network entity or another network entity prior to reception of the SSB, an indication of a pre-paging configuration associated with the cell ID, wherein determining the SS and the CORESET is based at least in part on the pre-paging configuration.

Aspect 6: The method of aspect 5, wherein determining the CORESET comprises: determining the CORESET based at least in part on a frequency resource via which the SSB is received.

Aspect 7: The method of any of aspects 5 through 6, wherein receiving the indication of the pre-paging configuration comprises: receiving an indication of a plurality of pre-paging configurations associated with a plurality of respective cell IDs, wherein the plurality of pre-paging configurations includes the pre-paging configuration, and wherein the plurality of respective cell IDs includes the cell ID.

Aspect 8: The method of any of aspects 5 through 7, wherein receiving the indication of the pre-paging configuration comprises: receiving SI from the NT network entity or the other network entity that includes the indication of the pre-paging configuration.

Aspect 9: The method of any of aspects 5 through 7, wherein receiving the indication of the pre-paging configuration comprises: receiving a unicast RRC message from the NT network entity or the other network entity that includes the indication of the pre-paging configuration.

Aspect 10: The method of any of aspects 1 through 9, further comprising: receiving, from the NT network entity or another network entity prior to reception of the SSB, an indication of a CORESET configuration associated with a set of cell IDs, wherein the set of cell IDs includes the cell ID, wherein the CORESET for the downlink control channel monitoring occasion is identified based at least in part on a frequency resource via which the SSB is received and the CORESET configuration; and receiving, from the NT network entity, a master information block that indicates the SS.

Aspect 11: The method of any of aspects 1 through 10, wherein the SSB includes an indication that the NT network entity supports pre-paging, the UE determines the SS and the CORESET based at least in part on the indication that the NT network entity supports pre-paging.

Aspect 12: The method of any of aspects 1 through 11, further comprising: receiving, from a second NT network entity, a second SSB including an indication that the second NT network entity does not support pre-paging, wherein the second SSB is indicative of a second cell ID of the second NT network entity; refraining, based at least in part on the indication that the second NT network entity does not support pre-paging and based at least in part on the second cell ID, from determining a second SS and a second CORESET for a second downlink control channel monitoring occasion for a second pre-paging message from the second NT network entity.

Aspect 13: A method for wireless communications at a NT network entity, comprising: transmitting, to a UE in an RRC idle mode or an RRC inactive mode with the NT network entity, an SSB, wherein the SSB is indicative of a cell ID of the NT network entity; and transmitting, to the UE via a downlink control channel monitoring occasion, a pre-paging message including a UE ID, wherein a SS and a CORESET for the downlink control channel monitoring occasion are based at least in part on the cell ID.

Aspect 14: The method of aspect 13, wherein transmitting the pre-paging message further comprises: transmitting, in the pre-paging message, an indication of a paging cause.

Aspect 15: The method of any of aspects 13 through 14, wherein transmitting the pre-paging message further comprises: transmitting a downlink control information with a CRC scrambled by a second part of a pre-paging ID for the UE, wherein the UE ID is a first part of the pre-paging ID for the UE.

Aspect 16: The method of aspect 15, further comprising: transmitting, to the UE prior to transmission of the SSB, an indication of the pre-paging ID for the UE.

Aspect 17: The method of any of aspects 13 through 16, further comprising: transmitting, to the UE prior to transmission of the SSB, an indication of a pre-paging configuration associated with the cell ID, wherein the SS and the CORESET for the downlink control channel monitoring occasion are based at least in part on the pre-paging configuration.

Aspect 18: The method of aspect 17, wherein the CORESET for the downlink control channel monitoring occasion is based at least in part on a frequency resource via which the SSB is transmitted.

Aspect 19: The method of any of aspects 17 through 18, wherein transmitting the indication of the pre-paging configuration comprises: transmitting an indication of a plurality of pre-paging configurations associated with a plurality of respective cell IDs, wherein the plurality of pre-paging configurations includes the pre-paging configuration, and wherein the plurality of respective cell IDs includes the cell ID.

Aspect 20: The method of any of aspects 17 through 19, wherein transmitting the indication of the pre-paging configuration comprises: transmitting SI that includes the indication of the pre-paging configuration.

Aspect 21: The method of any of aspects 17 through 19, wherein transmitting the indication of the pre-paging configuration comprises: transmitting a unicast RRC message that includes the indication of the pre-paging configuration.

Aspect 22: The method of any of aspects 13 through 21, further comprising: transmitting, to the UE prior to transmission of the SSB, an indication of a CORESET configuration associated with a set of cell IDs, wherein the set of cell IDs includes the cell ID, wherein the CORESET for the downlink control channel monitoring occasion is identified based at least in part on a frequency resource via which the SSB is received and the CORESET configuration; and transmitting, to the UE, a master information block that indicates the SS.

Aspect 23: The method of any of aspects 13 through 22, wherein the SSB includes an indication that the NT network entity supports pre-paging.

Aspect 24: A UE for wireless communications, comprising one or more memories storing processor-executable code, and one or more processors coupled with the one or more memories and individually or collectively operable to execute the code to cause the UE to perform a method of any of aspects 1 through 12.

Aspect 25: A UE for wireless communications, comprising at least one means for performing a method of any of aspects 1 through 12.

Aspect 26: A non-transitory computer-readable medium storing code for wireless communications, the code comprising instructions executable by a processor to perform a method of any of aspects 1 through 12.

Aspect 27: An NT network entity for wireless communications, comprising one or more memories storing processor-executable code, and one or more processors coupled with the one or more memories and individually or collectively operable to execute the code to cause the NT network entity to perform a method of any of aspects 13 through 23.

Aspect 28: An NT network entity for wireless communications, comprising at least one means for performing a method of any of aspects 13 through 23.

Aspect 29: A non-transitory computer-readable medium storing code for wireless communications, the code comprising instructions executable by a processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a non-terrestrial network entity while in a radio resource control idle mode or a radio resource control inactive mode, a synchronization signal block, wherein the synchronization signal block is indicative of a cell identifier of the non-terrestrial network entity;
determine, based at least in part on the cell identifier, a search space and a control resource set for a downlink control channel monitoring occasion for a pre-paging message from the non-terrestrial network entity, wherein the pre-paging message includes a UE identifier; and
receive, from the non-terrestrial network entity via the downlink control channel monitoring occasion, the pre-paging message.

2. The UE of claim 1, wherein, to receive the pre-paging message, the one or more processors are individually or collectively further operable to execute the code to cause the UE to:
receive, in the pre-paging message, an indication of a paging cause.

3. The UE of claim 1, wherein, to receive the pre-paging message, the one or more processors are individually or collectively operable to execute the code to cause the UE to:
receive a downlink control information with a cyclic redundancy check scrambled by a second part of a pre-paging identifier for the UE, wherein the UE identifier is a first part of the pre-paging identifier for the UE.

4. The UE of claim 3, wherein the one or more processors are individually or collectively further operable to execute the code to cause the UE to:
receive, from the non-terrestrial network entity or another network entity prior to reception of the synchronization signal block, an indication of the pre-paging identifier for the UE.

5. The UE of claim 1, wherein the one or more processors are individually or collectively further operable to execute the code to cause the UE to:
receive, from the non-terrestrial network entity or another network entity prior to reception of the synchronization signal block, an indication of a pre-paging configuration associated with the cell identifier, wherein determining the search space and the control resource set is based at least in part on the pre-paging configuration.

6. The UE of claim 5, wherein, to determine the control resource set, the one or more processors are individually or collectively operable to execute the code to cause the UE to:
determine the control resource set based at least in part on a frequency resource via which the synchronization signal block is received.

7. The UE of claim 5, wherein, to receive the indication of the pre-paging configuration, the one or more processors are individually or collectively operable to execute the code to cause the UE to:
receive an indication of a plurality of pre-paging configurations associated with a plurality of respective cell identifiers, wherein the plurality of pre-paging configurations includes the pre-paging configuration, and wherein the plurality of respective cell identifiers includes the cell identifier.

8. The UE of claim 5, wherein, to receive the indication of the pre-paging configuration, the one or more processors are individually or collectively operable to execute the code to cause the UE to:
receive system information from the non-terrestrial network entity or the other network entity that includes the indication of the pre-paging configuration.

9. The UE of claim 5, wherein, to receive the indication of the pre-paging configuration, the one or more processors are individually or collectively operable to execute the code to cause the UE to:
receive a unicast radio resource control message from the non-terrestrial network entity or the other network entity that includes the indication of the pre-paging configuration.

10. The UE of claim 1, wherein the one or more processors are individually or collectively further operable to execute the code to cause the UE to:
receive, from the non-terrestrial network entity or another network entity prior to reception of the synchronization signal block, an indication of a control resource set configuration associated with a set of cell identifiers, wherein the set of cell identifiers includes the cell identifier, wherein the control resource set for the downlink control channel monitoring occasion is identified based at least in part on a frequency resource via which the synchronization signal block is received and the control resource set configuration; and
receive, from the non-terrestrial network entity, a master information block that indicates the search space.

11. The UE of claim 1, wherein the synchronization signal block includes an indication that the non-terrestrial network entity supports pre-paging, wherein the UE determines the search space and the control resource set based at least in part on the indication that the non-terrestrial network entity supports pre-paging.

12. The UE of claim 1, wherein the one or more processors are individually or collectively further operable to execute the code to cause the UE to:
receive, from a second non-terrestrial network entity, a second synchronization signal block including an indication that the second non-terrestrial network entity does not support pre-paging, wherein the second synchronization signal block is indicative of a second cell identifier of the second non-terrestrial network entity; and
refrain, based at least in part on the indication that the second non-terrestrial network entity does not support pre-paging and based at least in part on the second cell identifier, from determining a second search space and a second control resource set for a second downlink control channel monitoring occasion for a second pre-paging message from the second non-terrestrial network entity.

13. A non-terrestrial network entity, comprising:
one or more memories storing processor-executable code; and
one or more processors coupled with the one or more memories and individually or collectively operable to execute the code to cause the non-terrestrial network entity to:
transmit, to a user equipment (UE) in a radio resource control idle mode or a radio resource control inactive mode with the non-terrestrial network entity, a synchronization signal block, wherein the synchronization signal block is indicative of a cell identifier of the non-terrestrial network entity; and
transmit, to the UE via a downlink control channel monitoring occasion, a pre-paging message including a UE identifier, wherein a search space and a control resource set for the downlink control channel monitoring occasion are based at least in part on the cell identifier.

14. The non-terrestrial network entity of claim 13, wherein, to transmit the pre-paging message, the one or more processors are individually or collectively further operable to execute the code to cause the non-terrestrial network entity to:
transmit, in the pre-paging message, an indication of a paging cause.

15. The non-terrestrial network entity of claim 13, wherein, to transmit the pre-paging message, the one or more processors are individually or collectively further operable to execute the code to cause the non-terrestrial network entity to:
transmit a downlink control information with a cyclic redundancy check scrambled by a second part of a pre-paging identifier for the UE, wherein the UE identifier is a first part of the pre-paging identifier for the UE.

16. The non-terrestrial network entity of claim 15, wherein the one or more processors are individually or collectively further operable to execute the code to cause the non-terrestrial network entity to:
transmit, to the UE prior to transmission of the synchronization signal block, an indication of the pre-paging identifier for the UE.

17. The non-terrestrial network entity of claim 13, wherein the one or more processors are individually or collectively further operable to execute the code to cause the non-terrestrial network entity to:
transmit, to the UE prior to transmission of the synchronization signal block, an indication of a pre-paging configuration associated with the cell identifier, wherein the search space and the control resource set for the downlink control channel monitoring occasion are based at least in part on the pre-paging configuration.

18. The non-terrestrial network entity of claim 17, wherein the control resource set for the downlink control channel monitoring occasion is based at least in part on a frequency resource via which the synchronization signal block is transmitted.

19. The non-terrestrial network entity of claim 17, wherein, to transmit the indication of the pre-paging configuration, the one or more processors are individually or collectively operable to execute the code to cause the non-terrestrial network entity to:
transmit an indication of a plurality of pre-paging configurations associated with a plurality of respective cell identifiers, wherein the plurality of pre-paging configurations includes the pre-paging configuration, and wherein the plurality of respective cell identifiers includes the cell identifier.

20. The non-terrestrial network entity of claim 17, wherein, to transmit the indication of the pre-paging configuration, the one or more processors are individually or collectively operable to execute the code to cause the non-terrestrial network entity to:
transmit system information that includes the indication of the pre-paging configuration.

21. The non-terrestrial network entity of claim 17, wherein, to transmit the indication of the pre-paging configuration, the one or more processors are individually or collectively operable to execute the code to cause the non-terrestrial network entity to:
transmit a unicast radio resource control message that includes the indication of the pre-paging configuration.

22. The non-terrestrial network entity of claim 13, wherein the one or more processors are individually or collectively further operable to execute the code to cause the non-terrestrial network entity to:
transmit, to the UE prior to transmission of the synchronization signal block, an indication of a control resource set configuration associated with a set of cell identifiers, wherein the set of cell identifiers includes the cell identifier, wherein the control resource set for the downlink control channel monitoring occasion is identified based at least in part on a frequency resource via which the synchronization signal block is received and the control resource set configuration; and
transmit, to the UE, a master information block that indicates the search space.

23. The non-terrestrial network entity of claim 13, wherein the synchronization signal block includes an indication that the non-terrestrial network entity supports pre-paging.

24. A method for wireless communications at a user equipment (UE), comprising:
receiving, from a non-terrestrial network entity while in a radio resource control idle mode or a radio resource control inactive mode, a synchronization signal block, wherein the synchronization signal block is indicative of a cell identifier of the non-terrestrial network entity;
determining, based at least in part on the cell identifier, a search space and a control resource set for a downlink control channel monitoring occasion for a pre-paging message from the non-terrestrial network entity, wherein the pre-paging message includes a UE identifier; and
receiving, from the non-terrestrial network entity via the downlink control channel monitoring occasion, the pre-paging message.

25. The method of claim 24, wherein receiving the pre-paging message further comprises:
receiving, in the pre-paging message, an indication of a paging cause.

26. The method of claim 24, wherein receiving the pre-paging message comprises:
receiving a downlink control information with a cyclic redundancy check scrambled by a second part of a pre-paging identifier for the UE, wherein the UE identifier is a first part of the pre-paging identifier for the UE.

27. The method of claim 26, further comprising:
receiving, from the non-terrestrial network entity or another network entity prior to reception of the synchronization signal block, an indication of the pre-paging identifier for the UE.

28. The method of claim 24, further comprising:
receiving, from the non-terrestrial network entity or another network entity prior to reception of the synchronization signal block, an indication of a pre-paging configuration associated with the cell identifier, wherein determining the search space and the control resource set is based at least in part on the pre-paging configuration.

29. The method of claim 28, wherein determining the control resource set comprises:
determining the control resource set based at least in part on a frequency resource via which the synchronization signal block is received.

30. A method for wireless communications at a non-terrestrial network entity, comprising:
transmitting, to a user equipment (UE) in a radio resource control idle mode or a radio resource control inactive mode with the non-terrestrial network entity, a synchronization signal block, wherein the synchronization signal block is indicative of a cell identifier of the non-terrestrial network entity; and
transmitting, to the UE via a downlink control channel monitoring occasion, a pre-paging message including a UE identifier, wherein a search space and a control resource set for the downlink control channel monitoring occasion are based at least in part on the cell identifier.
